(19) United States
(12) Patent Application Publication
(10) Pub. No.: US 2022/0242791 A1
(43) Pub. Date: Aug. 4, 2022

(54) Insulation Material and a Method for its Production

(71) Applicant: FIRST POINT A.S., Hodonin (CZ)

(72) Inventors: Gabriela Chlandová, Borohrádek (CZ); Petr Spaniel, Ceské Mezinci (CZ)

(73) Assignee: FIRST POINT A.S., Hodonin (CZ)

(21) Appl. No.: 17/627,669

(22) PCT Filed: Jun. 26, 2020
(86) PCT No.: PCT/CZ2020/000033

§ 371 Date: Jan. 15, 2022

(30) Foreign Application Priority Data
Aug. 7, 2019 (CZ) PV 2019-515

(51) Int. Cl. C04B 28/26; C04B 16/08; C04B 14/30; C04B 14/22; C04B 20/10; C04B 40/00

(52) U.S. Cl. CPC C04B 28/26; C04B 16/082; C04B 14/303; C04B 2111/28; C04B 20/1092; C04B 40/0046; C04B 14/22

(57) ABSTRACT

An insulating material, in particular a permeable fire-proof insulating material comprising water glass and which is composed of a air harden-able compound which contains 2 to 40 wt % of plastic balls, 55 to 95.0 wt % of aqueous sodium silicate solution, 2 to 6 wt % of aluminium hydroxide, and 0.1 to 0.5 wt % water glass stabiliser. A method for the production of insulating material, in particular a method for the production of permeable fire-proof insulating material comprising water glass and plastic balls, according to which firstly the plastic balls are mixed with an aqueous solution of carbon black so as to coat their entire surface, then is added to the aqueous sodium silicate solution aluminium hydroxide and the whole is mixed so as to form an insulating mixture, and then a water glass stabiliser is added to the aqueous sodium silicate solution, and then to this solution is mixed water glass hardener, with this solution being further stirred for 1 to 10 minutes to form a binder solution, and the insulating mixture is added to the binder solution with constant stirring, and the whole is mixed, and the resulting mixture is then poured into the application site.

### TECHNICAL FIELD

The invention relates to an insulating material, in particular a permeable fire-proof insulating material containing water glass, and to a method for its production.

### STATE OF THE ART

From current technology the use of insulating materials for insulating various types of buildings is known.

For the insulation of horizontal surfaces, polystyrene panels as well as modern sprayed insulation made of PUR foam are used. The disadvantage of this foam is its lower fire resistance and rapid ageing.

Another known method of insulating horizontal and vertical surfaces is mineral wool insulation. Mineral wool has a higher fire resistance, but it is absorbent, so it loses its insulating properties and mould forms in it.

From the patent application CZ PV2017-127 an acoustic and thermal insulator for use in construction is known, which consists of a slurry in an air-hardening mixture containing 5 to 76 wt % of bulk thermal insulation material with a specific volumetric mass of less than 300 kg/m³, 9 to 36 wt % of brick dust fractions 0.001 to 1 mm, 6 to 30 wt % of water glass, 7 to 30 wt % of water and up to 5 wt % detergent. The disadvantage of this material is that it has lower thermal insulation properties, higher flammability and less cohesion.

From the utility model CZ 31095 a mixture for a permeable fire-proof lightweight polystyrene thermal insulation system is known, which contains 10 wt % of expanded polystyrene beads with a diameter of 3 to 6 mm, 88 wt % of sodium silicate water glass, 1 wt % carbon black, and 1 wt % water glass stabiliser—hydrophilic alkoxy alkyl-ammonium salts. The disadvantage of this mixture is that the carbon black is not a protection on the surface of the balls, but is freely dispersed in the insulating material, which causes higher thermal conductivity of the insulating material and low thermal stability and thus limited fire-proofing properties, lower resistance to UV radiation and therefore it degrades very quickly.

From the aforementioned current technology it is clear that main disadvantages of current technology are the lower insulating properties of the known materials and the higher rate of their degradation.

The object of the invention is the construction of a light insulating material which will have high fire resistance, while at the same time being flexible and pliable and, be resistant to degradation.

### PRINCIPLE OF THE INVENTION

The above-mentioned drawbacks are largely eliminated and the objects of the invention, according to the first variant, are fulfilled by an insulating material, in particular a permeable fire-proof insulating material containing water glass, which according to the invention is characterised by that it consists of a hardening mixture which contains 2 to 40 wt % of plastic balls, 55 to 95.0 wt % of aqueous sodium silicate solution, 2 to 6 wt % of aluminium hydroxide, and 0.1 to 0.5 wt % water glass stabiliser.

In an advantageous version, the plastic balls are hollow plastic balls.

The advantage of this insulating material is significantly higher thermal stability as well as significantly improved fire-proof properties, the resistance to UV radiation is higher and the degree of degradation is significantly lower. An advantage is also very good permeability. To improve flame retardancy, the mixture contains aluminium hydroxide.

To advantage the plastic balls have a diameter of 1 to 50 mm, while to greatest advantage they are made of polypropylene. In other advantageous variants, the plastic ball material may be polyethylene or polyurethane or polymethyl methacrylate or polyamide or polyvinyl chloride or polyester or phenoplast or aminoplast or Teflon. The advantage is the possibility of optimising the structure of the material with regard to optimal arrangement.

It is to great advantage if the surface of the plastic balls is provided with carbon black, the pure carbon black constituting 0.025 to 0.25 wt % of total weight. The advantage is that the carbon black thus provided reduces radiation transmittance and does not increase thermal conductivity. A further advantage is that carbon black acts as a flame retardant and dampens the retardation of plastics.

It is also to advantage that the water glass stabilisers are hydrophilic alkoxy alkyl-ammonium salts.

A great advantage is then that the aqueous sodium silicate solution has a density in the range of 1370 to 1400 kg/m³ and the molar ratio of SiO₂ and Na₂O is in the range of 3.2 to 3.4. The molar mass ratio of silica to sodium oxide and the associated solution density and solution concentration have a significant effect on the rheological properties of water glass as a polymer mixture, on the electrical properties, compressibility and adhesive strength as in an electrolyte, further to hardness, strength, etc. The advantage of the above stated parameters is that the resulting insulating material is partially flexible and pliable after solidification.

The insulating material to further advantage comprises a hardener, which may be glycerol mono to triacetate or a compound of these.

The mentioned disadvantages are largely removed and the objectives of the invention are fulfilled by a method for producing insulating material, specifically a method for producing permeable fire-proof insulating material containing water glass and plastic balls, which according to the invention is characterised by that firstly plastic balls are mixed with an aqueous carbon black solution in such a way that their entire surface is coated, then aluminium hydroxide is added and the whole is mixed to form an insulating mixture, and then a water glass stabiliser is added to the aqueous sodium silicate solution, and then a water glass hardener is mixed into the solution. This solution is stirred for 1 to 10 minutes to form a binder solution, and then the insulating mixture is poured into the binder solution while constantly stirring, and the whole is mixed, and then the resulting mixture is poured onto the application site. The advantage is that it is possible to produce both solid products, such as insulation panels and fittings, and the insulation material can even be applied in its liquid state.

It is advantageous if the resulting compound is poured into the application site, which is the mould, and further a sufficient amount of binder solution is extruded from the resulting compound by means of a press so as to produce the desired ratio of insulating compound and binder solution. The advantage is that it is possible to easily produce a product with precise parameters.

It is also advantageous if the resulting mixture is finally left to stand until cured. The advantage is that the resulting insulation can be created exactly with respect to the shape parameters of the insulated space, with the fact that due to the fact that the curing length can be regulated, the insulation material can be precisely shaped into the desired shape.

The main advantage of the insulating material and the method of its production according to the invention is that it has comparable insulating properties as the insulating materials used so far, while unlike existing materials it is non-flammable, vapour permeable, resistant to rainwater and moisture, anti-fungal, strong, flexible, resistant to external influences such as UV radiation. Another advantage is the simple methods of application. It is possible to create both cladding boards and fittings from the insulating material, and it can be easily applied as a liquid mixture by stretching, casting and spraying. The insulating material is thus suitable for floors and ceilings, horizontal and slightly sloping roofs, where it replaces mineral wool, polystyrene concrete or polyurethane foam. Unlike insulation with mineral wool or polystyrene boards, it is well applied to hard-to-reach places and to rugged edges of the surface. It has good adhesion to various substrates, including trapezoidal and folded sheets, Eternit or asphalt, which are usually on roofs. At the same time, the insulating material is strong enough, it can also be walkable. A great advantage of the insulating material according to the invention over the existing materials is also the possibility of combining boards and a liquid mixture. One of the problems associated with the anchoring of conventional polystyrene boards is the filling of joints between the boards and the holes around the dowels. Thanks to the possibility of filling these gaps and openings with a liquid form of insulating material, a uniform surface without thermal bridges is created very easily and quickly. A great advantage is also that the semi-finished insulating material in the form of a liquid mixture can be applied as an insulating lining in industry, e.g., appliances, electrical technology, automotive, etc.

### EXAMPLES OF THE PERFORMANCE OF THE INVENTION

### Example 1

The permeable fire-proof insulating material is composed of an air-hardening compound which contains 12 wt % hollow plastic balls, which are polypropylene balls with a diameter of 5 to 10 mm, 81.0 wt % of aqueous sodium silicate solution, 4 wt % of aluminium hydroxide, 0.3 wt % water glass stabiliser and 2.3 wt % hardeners.

The surface of the hollow plastic balls is provided with carbon black, the carbon black constituting 0.4 wt % of total weight.

Alternatively, the material of the hollow plastic beads may be polyethylene or polyurethane or polymethyl methacrylate or polyamide or polyvinyl chloride or polyester or phenoplast or aminoplast or Teflon.

The water glass stabilisers are hydrophilic alkoxy alkyl-ammonium salts, in the form of a 98% aqueous solution of N,N,N′,N′-Tetrakis (2-hydroxypropyl) ethylenediamine.

The aqueous sodium silicate solution has a density in the range of 1390 kg/m³ and a molar ratio of SiO₂ to Na₂O of 3.3.

The water glass hardener is a compound of pure glycerol diacetate/triacetate in a ratio of 7:3 by volume, with a concentration of 2.8 wt % to clear water glass.

According to the method of manufacturing the insulating material, the hollow plastic balls are first mixed with an aqueous solution with a concentration of 25 wt % carbon black so that their entire surface is coated with carbon black, aluminium hydroxide is added and the whole is mixed to form an insulating compound, then added to an aqueous solution of sodium silicate is a water glass stabiliser, followed by a water glass hardener being added to the solution, this solution being mixed for 5 minutes to form a binder solution, and then the insulating mixture is added to the binder solution with constant stirring, and the whole is mixed, and the resulting mixture is poured into an application site which is a silicone mould, and further, from the resulting mixture such an amount of binder solution is extruded by means of a press so that the desired ratio of insulating mixture and binder solution is obtained.

Finally, the resulting mixture is left undisturbed until hardened. The resulting product is an insulating board, or an insulating layer arranged on an OSB board, more precisely between two OSB boards.

### Example 2

The permeable fire-proof insulating material is composed of an air-hardening compound which contains 2 wt % of hollow plastic balls, which are polypropylene spheres with a diameter of 1 to 5 mm, 95.0 wt % of aqueous sodium silicate solution, 2 wt % of aluminium hydroxide, 0.1 wt % water glass stabiliser and 0.8 wt % hardeners.

The surface of the hollow plastic balls is provided with carbon black, the carbon black being 0.1 wt % of total weight.

Alternatively, the material of the hollow plastic balls may be polyethylene or polyurethane or polymethyl methacrylate or polyamide or polyvinyl chloride or polyester or phenoplast or aminoplast or Teflon.

The water glass stabilisers are hydrophilic alkoxy alkyl-ammonium salts, in the form of a 98% aqueous solution of N,N,N′,N′-Tetrakis (2-hydroxypropyl) ethylenediamine.

An aqueous solution of sodium silicate having a density in the range of 1370 kg/m³ and a molar ratio of SiO₂ to Na₂O in the range of 3.2.

The water glass hardener is a compound of pure glycerol diacetate/triacetate in a ratio of 7:3 by volume, with a concentration of 0.8 wt % to clear water glass.

According to the method for producing the insulating material, firstly the hollow plastic balls are mixed with an aqueous solution with a concentration of 25 wt % of carbon black so that their entire surface is coated with carbon black, then aluminium hydroxide is added and the whole is mixed to form an insulating mixture, then added to an aqueous solution of sodium silicate is a water glass stabiliser, followed by a water glass hardener being added to the solution, this solution being mixed for 1 minute to form a binder solution, and then the insulating mixture is added to the binder solution with constant stirring, and the whole is mixed, and the resulting mixture is poured into a flat, divided attic space, spread, surface-treated and left undisturbed to harden.

### Example 3

The permeable fire-proof insulating material is composed of an air-hardening compound which contains 39 wt % of hollow plastic balls with a diameter of 10 to 50 mm, 55 wt % of aqueous sodium silicate solution, 2.5 wt % of aluminium hydroxide, 0.5 wt % water glass stabiliser and 2 wt % hardeners.

The material of the hollow plastic balls is polypropylene.

Alternatively, the material of the hollow plastic beads may be polyethylene or polyurethane or polymethyl methacrylate or polyamide or polyvinyl chloride or polyester or phenoplast or aminoplast or Teflon.

The surface of the hollow plastic balls is provided with carbon black, the carbon black constituting 1 wt % of total weight.

The water glass stabilisers are hydrophilic alkoxy alkyl-ammonium salts, in the form of a 98% aqueous solution of N,N,N′,N′-Tetrakis (2-hydroxypropyl) ethylenediamine.

An aqueous solution of sodium silicate having a density in the range of 1400 kg/m³ and a molar ratio of SiO₂ to Na₂O in the range of 3.4.

The water glass hardener is a compound of pure glycerol diacetate/triacetate in a ratio of 7:3 by volume, with a concentration of 4.5 wt % to clear water glass.

According to the method for producing the insulating material, firstly the hollow plastic balls are mixed with an aqueous solution with a concentration of 25 wt % of carbon black so that their entire surface is coated with carbon black, then aluminium hydroxide is added and the whole is mixed to form an insulating mixture, then added to an aqueous solution of sodium silicate is a water glass stabiliser, followed by a water glass hardener being added to the solution, this solution being mixed for 10 minutes to form a binder solution, and then the insulating mixture is added to the binder solution with constant stirring, and the whole is mixed, and the resulting mixture is then poured onto the outer wall of a building provided with formwork with a silicone surface and finally, the resulting mixture is left undisturbed to harden, after which the formwork is removed.

### Example 4

The permeable fire-proof insulating material is composed of an air-hardening compound which contains 12 wt % of plastic balls, which are polypropylene balls with a diameter of 5 to 10 mm, 81.0 wt % of aqueous sodium silicate solution, 4 wt % of aluminium hydroxide, 0.3 wt % water glass stabiliser and 2.3 wt % hardeners.

The surface of the plastic balls is provided with carbon black, the carbon black constituting 0.4 wt % of total weight.

Alternatively, the material of the plastic spheres may be polyethylene or polyurethane or polymethyl methacrylate or polyamide or polyvinyl chloride or polyester or phenoplast or aminoplast or Teflon.

The water glass stabilisers are hydrophilic alkoxy alkyl-ammonium salts, in the form of a 98% aqueous solution of N,N,N′,N′-Tetrakis (2-hydroxypropyl) ethylenediamine.

The aqueous sodium silicate solution has a density in the range of 1390 kg/m³ and a molar ratio of SiO₂ to Na₂O of 3.3.

The water glass hardener is a compound of pure glycerol diacetate/triacetate in a ratio of 7:3 by volume, with a concentration of 2.8 wt % to clear water glass.

According to the method for producing the insulating material, firstly the plastic balls are mixed with an aqueous solution with a concentration of 25 wt % of carbon black so that their entire surface is coated with carbon black, then aluminium hydroxide is added and the whole is mixed to form an insulating mixture, then added to an aqueous solution of sodium silicate is a water glass stabiliser, followed by a water glass hardener being added to the solution, this solution being mixed for 5 minutes to form a binder solution, and then the insulating mixture is added to the binder solution with constant stirring, and the whole is mixed, and the resulting mixture is then poured into an application site which is a silicone mould, and further, from the resulting mixture such an amount of binder solution is extruded by means of a press so that the desired ratio of insulating mixture and binder solution is obtained.

Finally, the resulting mixture is left undisturbed until hardened. The resulting product is an insulating board, or an insulating layer arranged on an OSB board, more precisely between two OSB boards.

### Example 5

The permeable fire-proof insulating material is composed of an air-hardening compound which contains 2 wt % of plastic balls, which are polypropylene balls with a diameter of 1 to 5 mm, 95.0 wt % of aqueous sodium silicate solution, 2 wt % of aluminium hydroxide, 0.1 wt % water glass stabiliser and 0.8 wt % hardeners.

The surface of the plastic balls is provided with carbon black, the carbon black constituting 0.1 wt % of total weight.

Alternatively, the material of the plastic spheres may be polyethylene or polyurethane or polymethyl methacrylate or polyamide or polyvinyl chloride or polyester or phenoplast or aminoplast or Teflon.

The water glass stabilisers are hydrophilic alkoxy alkyl-ammonium salts, in the form of a 98% aqueous solution of N,N,N′,N′-Tetrakis (2-hydroxypropyl) ethylenediamine.

An aqueous solution of sodium silicate having a density in the range of 1370 kg/m³ and a molar ratio of SiO₂ to Na₂O in the range of 3.2.

The water glass hardener is a compound of pure glycerol diacetate/triacetate in a ratio of 7:3 by volume, with a concentration of 0.8 wt % to clear water glass.

According to the method for producing the insulating material, firstly the plastic balls are mixed with an aqueous solution with a concentration of 25 wt % of carbon black so that their entire surface is coated with carbon black, then aluminium hydroxide is added and the whole is mixed to form an insulating mixture, then added to an aqueous solution of sodium silicate is a water glass stabiliser, followed by a water glass hardener being added to the solution, this solution being mixed for 1 minute to form a binder solution, and then the insulating mixture is added to the binder solution with constant stirring, and the whole is mixed, and the resulting mixture is poured into a flat, divided attic space, spread, surface-treated and left undisturbed to harden.

### Example 6

The permeable fire-proof insulating material is composed of an air-hardening compound which contains 39 wt % of plastic balls with a diameter of 10 to 50 mm, 55 wt % of aqueous sodium silicate solution, 2.5 wt % of aluminium hydroxide, 0.5 wt % water glass stabiliser and 2 wt % hardeners.

The material of the plastic balls is polypropylene.

Alternatively, the material of the plastic spheres may be polyethylene or polyurethane or polymethyl methacrylate or polyamide or polyvinyl chloride or polyester or phenoplast or aminoplast or Teflon.

The surface of the plastic balls is provided with carbon black, the carbon black constituting 1 wt % of total weight.

The water glass stabilisers are hydrophilic alkoxy alkyl-ammonium salts, in the form of a 98% aqueous solution of N,N,N′,N′-Tetrakis (2-hydroxypropyl) ethylenediamine.

An aqueous solution of sodium silicate having a density in the range of 1400 kg/m³ and a molar ratio of SiO₂ to Na₂O in the range of 3.4.

The water glass hardener is a compound of pure glycerol diacetate/triacetate in a ratio of 7:3 by volume, with a concentration of 4.5 wt % to clear water glass.

According to the method for producing the insulating material, firstly the plastic balls are mixed with an aqueous solution with a concentration of 25 wt % of carbon black so that their entire surface is coated with carbon black, then aluminium hydroxide is added and the whole is mixed to form an insulating mixture, then added to an aqueous solution of sodium silicate is a water glass stabiliser, followed by a water glass hardener being added to the solution, this solution being mixed for 10 minutes to form a binder solution, and then the insulating mixture is added to the binder solution with constant stirring, and the whole is mixed, and the resulting mixture is then poured onto the outer wall of a building provided with formwork with a silicone surface and finally, the resulting mixture is left undisturbed to harden, after which the formwork is removed.

### INDUSTRIAL APPLICATION

The insulating material according to the invention can in particular be used to create a permeable fire-proof insulating system in the building industry.

1. A permeable fire-proof insulating material, comprising water glass a harden-able compound comprising 2 to 40 wt % of plastic balls, 55 to 95.0 wt % of aqueous sodium silicate solution, 2 to 6 wt % of aluminum hydroxide, and 0.1 to 0.5 wt % water glass stabilizer.

2. The insulating material according to claim 1, wherein the plastic balls are hollow plastic balls.

3. The insulating material according to claim 1, wherein the plastic balls have a diameter of 1 to 50 mm.

4. The insulating material according to claim 1, wherein the material of the plastic spheres is polypropylene.

5. The insulating material according to claim 1, wherein the material of the plastic spheres is polyethylene or polyurethane or polymethyl methacrylate or polyamide or polyvinyl chloride or polyester or phenoplast or aminoplast or Teflon.

6. The insulating material according to claim 1, wherein the surface of the plastic balls is provided with carbon black, the carbon black constituting 0.1 to 1 wt % of total weight.

7. The insulating material according to claim 1, wherein the water glass stabilizers are hydrophilic alkoxy alkyl-ammonium salts.

8. The insulating material according to claim 1, wherein the aqueous sodium silicate solution has a density in the range from 1370 to 1400 kg/m³.

9. The insulating material according to claim 1, wherein the aqueous sodium silicate solution has a molar ratio of Si0₂ to Na₂0 in the range from 3.2 to 3.4.

10. The insulating material according to claim 1, wherein the insulating material further comprises a water glass hardener.

11. A method for producing a breathable fire insulation material comprising water glass and plastic balls according to claim 1, wherein in a first step the plastic balls are mixed with an aqueous solution of carbon black so as to coat their entire surface, the resulting plastic balls are then added to the aqueous sodium silicate solution aluminum hydroxide and the whole is mixed so as to form an insulating mixture, and then in a second step a water glass stabilizer is added to the aqueous sodium silicate solution, and then to this solution is mixed a water glass hardener, with this solution being further stirred for 1 to 10 minutes to form a binder solution, after which the insulating mixture is added to the binder solution with constant stirring, and the whole is mixed, and the resulting mixture is then poured into the application site.

12. The method for producing insulating material according to claim 11, wherein the resulting mixture is poured into the application site, which is a mould, and further, from the resulting mixture such an amount of binder solution is extruded by means of a press so that a desired ratio of insulating mixture and binder solution is obtained.

13. The method for producing insulating material according to claim 11, after the resulting mixture is poured into the application site, it is left undisturbed to harden.
